(19) United States
(12) Patent Application Publication
(10) Pub. No.: US 2010/0011931 A1
(43) Pub. Date: Jan. 21, 2010

(54) PLASTIC FILM CUTTING DEVICE

(76) Inventor: Wen-Lung Chang, Taichung City (TW)

Correspondence Address: LADAS & PARRY, 5670 WILSHIRE BOULEVARD, SUITE 2100, LOS ANGELES, CA, 90036-5679, US

(21) Appl. No.: 12/174,446

(22) Filed: Jul. 16, 2008

(51) Int. Cl. B26D 1/60

(52) U.S. Cl. 83/614

(57) ABSTRACT

A plastic film cutting device includes: a casing adapted to receive a roll of a plastic film therein and having an open end that defines an access opening for access into the casing, and a lid connected to the open end for covering and uncovering the access opening, the lid having first and second ends opposite to each other in a lengthwise direction; and a cutting unit including a first cutting member disposed in the casing, movable between the first and second ends of the lid in the lengthwise direction, and abutting resiliently against the lid for cutting the plastic film therebetween.

### BACKGROUND OF THE INVENTION

1. Field of the Invention

The invention relates to a plastic film cutting device, more particularly to a plastic film cutting device including a cutting member disposed movably in a casing and abutting resiliently against a lid of the casing.

2. Description of the Related Art

A conventional plastic film cutting device normally includes a casing for receiving a roll of a plastic film and a thin cutting member attached to an exterior of the casing for cutting a desired length of the plastic film drawn from the roll. The conventional plastic film cutting device is disadvantageous in that a smooth cut of the plastic film using the cutting member is difficult to achieve.

### SUMMARY OF THE INVENTION

Therefore, the object of the present invention is to provide a plastic film cutting device that can overcome the aforesaid drawback associated with the prior art.

Accordingly, a plastic film cutting device of the present invention comprises: a casing adapted to receive a roll of a plastic film therein and having an open end that defines an access opening for access into the casing, and a lid connected to the open end for covering and uncovering the access opening, the lid having first and second ends opposite to each other in a lengthwise direction; and a cutting unit including a cutting member disposed in the casing, movable between the first and second ends of the lid in the lengthwise direction, and abutting resiliently against the lid for cutting the plastic film therebetween.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view of the first preferred embodiment of a plastic film cutting device according to the present invention, illustrating a state where a cutter seat is disposed at a first position;

FIG. 2 is a side sectional view of the first preferred embodiment;

FIG. 3 is a sectional view of the first preferred embodiment illustrating a state where the cutter seat is disposed at a second position;

FIG. 4 is a sectional view of the second preferred embodiment of the plastic film cutting device according to this invention;

FIG. 5 is a sectional view of the third preferred embodiment of the plastic film cutting device according to the present invention;

FIG. 6 is a sectional view of the fourth preferred embodiment of the plastic film cutting device according to the present invention;

FIG. 7 is a sectional view of the fifth preferred embodiment of the plastic film cutting device according to the present invention;

FIG. 8 is a sectional view of the sixth preferred embodiment of the plastic film cutting device according to the present invention; and

FIG. 9 is a side sectional view of the seventh preferred embodiment of the plastic film cutting device according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

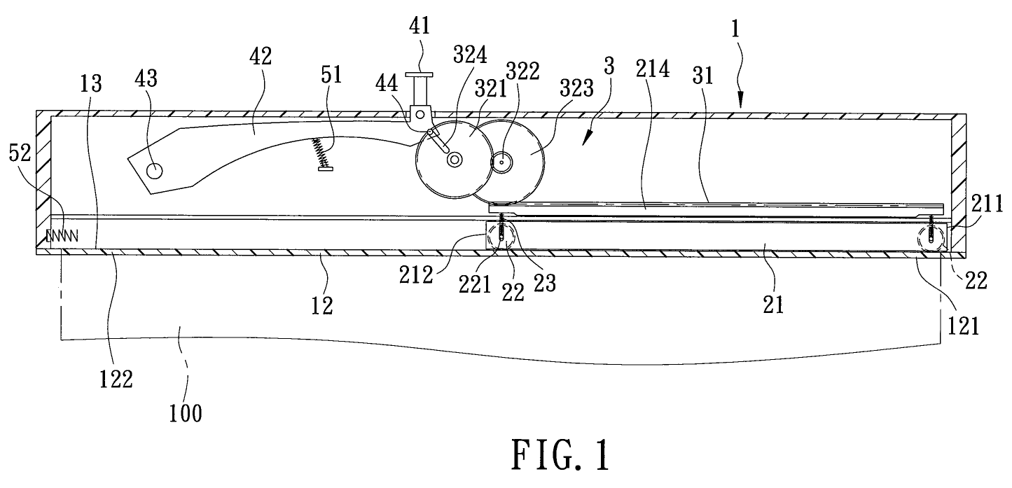

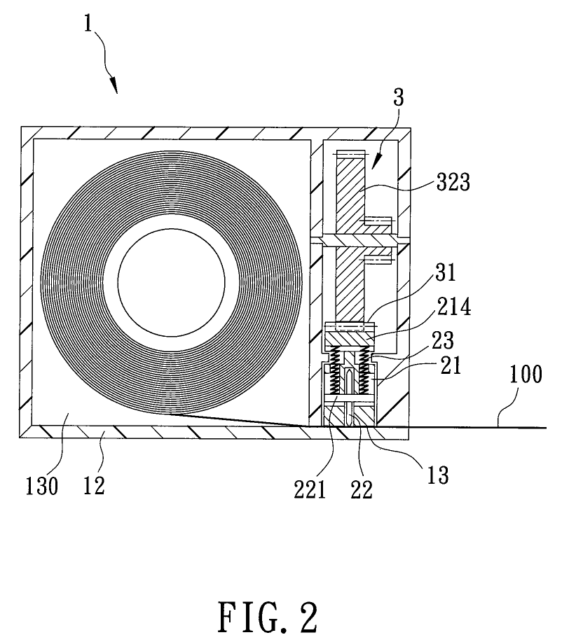

Referring to FIGS. 1 and 2, the first preferred embodiment of a plastic film cutting device according to the present invention includes: a casing 1 adapted to receive a roll of a plastic film 100 therein and having an open end 13 that defines an access opening 130 for access into the casing 1, and a lid 12 connected to the open end 13 for covering and uncovering the access opening 130, the lid 12 having first and second ends 121, 122 opposite to each other in a lengthwise direction; and a cutting unit including first and second cutting members 22 disposed in the casing 1, movable between the first and second ends 121, 122 of the lid 12 in the lengthwise direction, and abutting resiliently against the lid 12 for cutting the plastic film 100 therebetween. The cutting unit further includes a cutter seat 21 disposed slidably in the casing 1, movable in the lengthwise direction, and having two opposite ends 211, 212 opposite to each other in the lengthwise direction. The first and second cutting members 22 are mounted on the ends 211, 212 of the cutter seat 21, respectively. In this embodiment, the first and second cutting members 22 are cutter wheels.

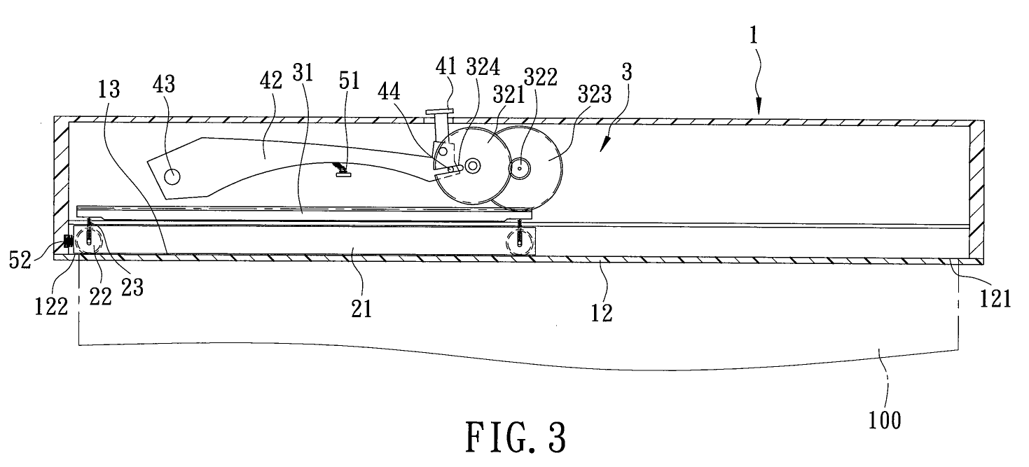

The cutter seat 21 is movable in the lengthwise direction between a first position (see FIG. 1), in which the first cutting member 22 is disposed at the first end 121 of the lid 12 and the second cutting member 22 is disposed at a middle position between the first and second ends 121, 122 of the lid 12, and a second position (see FIG. 3), in which the second cutting member 22 is disposed at the second end 122 of the lid 12 and the first cutting member 22 is disposed at the middle position between the first and second ends 121, 122 of the lid 12.

The cutting unit further includes two axles 221 each mounted on the cutter seat 21 and extending through a respective one of the first and second cutting members 22, and two pairs of first urging members 23, the first urging members 23 in each pair being disposed respectively at two opposite sides of a respective one of the first and second cutting members 22 and extending between and abutting against a top plate 214 of the cutter seat 21 and a respective one of the axles 221 for urging the first and second cutting members 22 toward the lid 12. In this embodiment, the first urging members 23 are in the form of coil springs.

The plastic film cutting device further includes a driving unit having a gear set 3 connected to the cutter seat 21, a driving arm 42 pivoted to the casing 1 through a pivot pin 43 and connected to the gear set 3, and an operating knob 41 connected and transverse to the driving arm 42 and extending outwardly through the casing 1 for driving rotation of the driving arm 42 and the gear set 3 and movement of the cutter seat 21 between the first and second positions.

The gear set 3 includes a first gear 321 that is formed with a radially extending notch 324. The driving arm 42 is provided with a driving pin 44 transverse to the first gear 321 and extending through and movable along the length of the radially extending notch 324 in the first gear 321 for pushing the first gear 321 and driving rotation of the first gear 321 and movement of the cutter seat 21 between the first and second positions. The driving arm 42 is rotatable about the pivot pin 43 from an upper position (see FIG. 1) to a lower position (see FIG. 3) for moving the cutter seat 21 from the first position to the second position. In addition, the driving unit further includes a second urging member 51 mounted on the casing 1 and abutting against the driving arm 42 for restoring the driving arm 42 to the upper position. The plastic film cutting device further includes a third urging member 52 mounted on the casing 1 and disposed adjacent to the second end 122 of the lid 12 for restoring the cutter seat 21 to the first position. In this embodiment, both the second and third urging members 51, 52 are in the form of coil springs.

The gear set 3 further includes a second gear 323, a gear rack 31 provided on the top plate 214 of the cutter seat 21 and meshed with the second gear 323, and a third gear 322 meshed with the first and second gears 321, 323 such that rotation of the first, second and third gears 321, 323, 322 results in movement of the gear rack 31 together with the cutter seat 21 in the lengthwise direction.

Note that the sizes of the first, second and third gears 321, 322, 323 and the number of the first and second cutting members 22 can be varied according to actual requirements.

Preferably, a catch (not shown) is mounted in the notch 324 in the first gear 321 to catch the driving pin 44 so as to retain the cutter seat 21 at one of the first and second positions. As such, the cutting unit can perform a cutting action on the plastic film 100 each time the operating knob 41 is moved downward to the lower position or moved upward to the upper position.

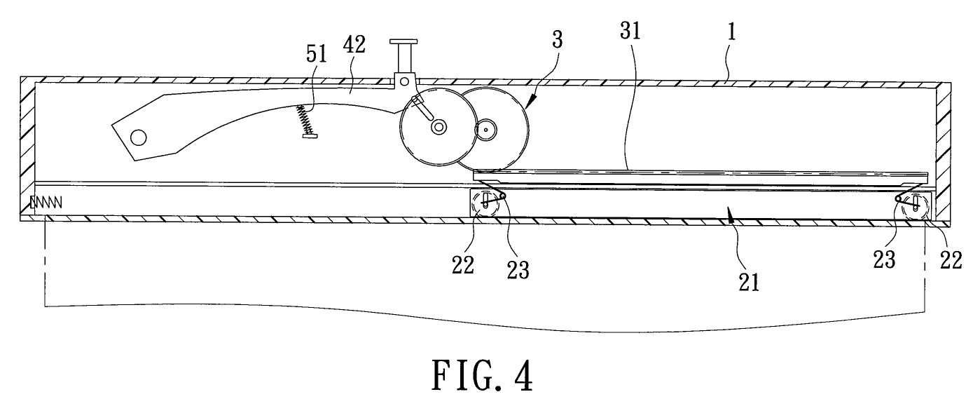

Referring to FIG. 4, the second preferred embodiment of the plastic film cutting device according to this invention is shown and differs from the previous embodiment in that the first urging members 23 are in the form of torsion springs.

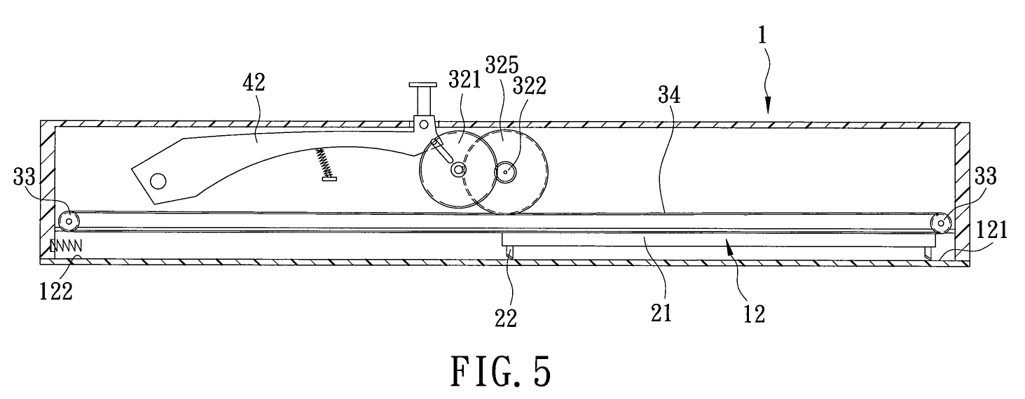

Referring to FIG. 5, the third preferred embodiment of the plastic film cutting device according to this invention is shown and differs from the first preferred embodiment in that the driving unit includes a pair of pulleys 33 mounted on the casing 1 and disposed adjacent to the first and second ends 121, 122 of the lid 12, respectively, a belt wheel 325 connected to the first gear 321 through the third gear 322 and disposed between the pulleys 33, and a driving belt 34 trained on the pulleys 33 and the belt wheel 325 and connected to the cutter seat 21 for driving movement of the cutter seat 21 between the first and second positions. In this embodiment, the gear rack 31 is dispensed with, the second gear 323 is replaced with the belt wheel 325, and the first and second cutting members 222, 223 are in the form of non-circular blades.

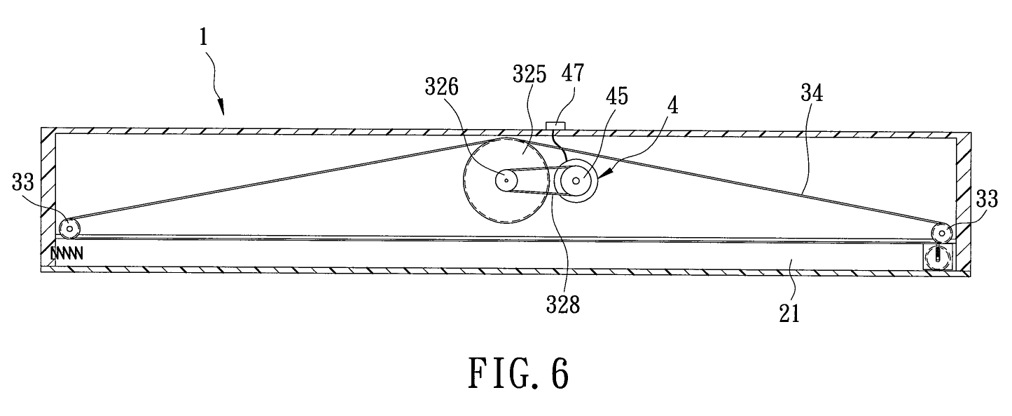

Referring to FIG. 6, the fourth preferred embodiment of the plastic film cutting device according to this invention is shown and differs from the third preferred embodiment in that the driving unit includes a switch 47 mounted on the exterior of the casing 1, a motor 4 actuated by the switch 47, a driving wheel 45 driven by the motor 4, a driven wheel 326 connected to the belt wheel 325, and a second driving belt 328 trained on the driving and driven wheels 45, 326 for driving rotation of the belt wheel 325 and movement of the driving belt 34 together with the cutter seat 21.

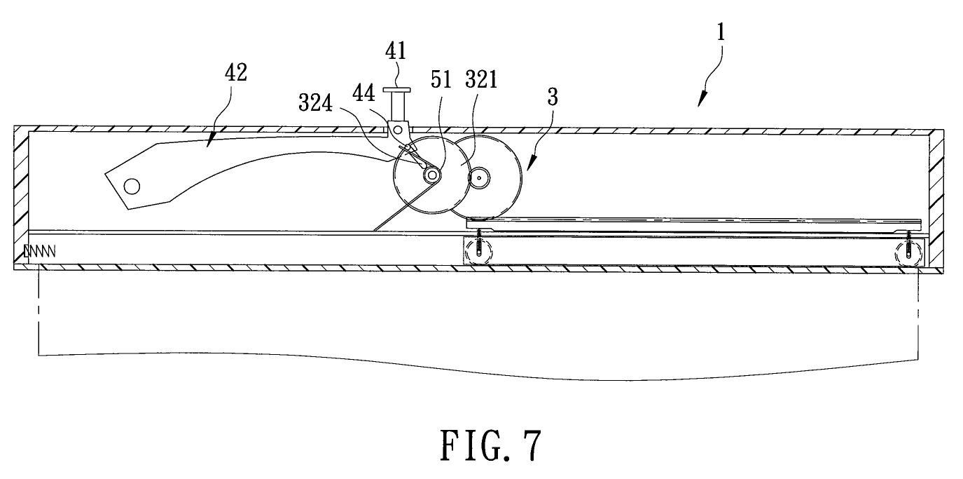

Referring to FIG. 7, the fifth preferred embodiment of the plastic film cutting device according to this invention is shown and differs from the first preferred embodiment in that the second urging member 51 is in the form of a torsion spring, is mounted on an axle of the first gear 321, and abuts against the driving pin 44 of the driving arm 42 for restoring the driving arm 42 to the upper position.

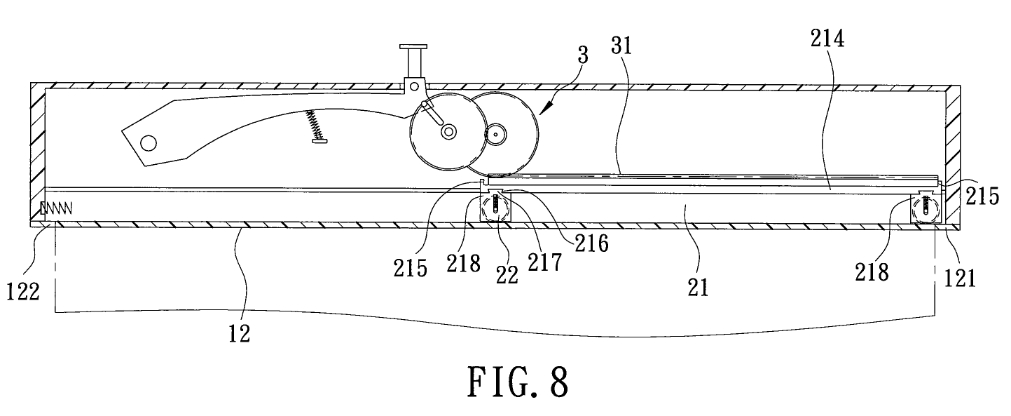

Referring to FIG. 8, the sixth preferred embodiment of the plastic film cutting device according to this invention is shown and differs from the first preferred embodiment in that the cutter seat 21 has a top plate 214 that has two opposite ends and that is formed with two abutting protrusions 215 protruding upwardly from the ends thereof, respectively. The gear rack 31 is mounted movably on the top plate 214, and is disposed between the ends of the top plate 214 for abutting against one of the abutting protrusions 215 when the gear rack 31 is moved toward the second end 122 of the lid 12, and for abutting against the other of the abutting protrusions 215 when the gear rack 31 is moved toward the first end 121 of the lid 12 (see FIG. 8). In this embodiment, the cutter seat 21 further has a pair of cutter-holding bodies 218, each of which is detachably connected to and engages the top plate 214 in a wedging manner. The first cutting members 22 are mounted on the cutter-holding bodies 218, respectively. The cutter seat 21 is formed with two wedging grooves 216. Each of the cutter-holding bodies 218 has a wedging protrusion 217 extending into a respective one of the wedging grooves 216.

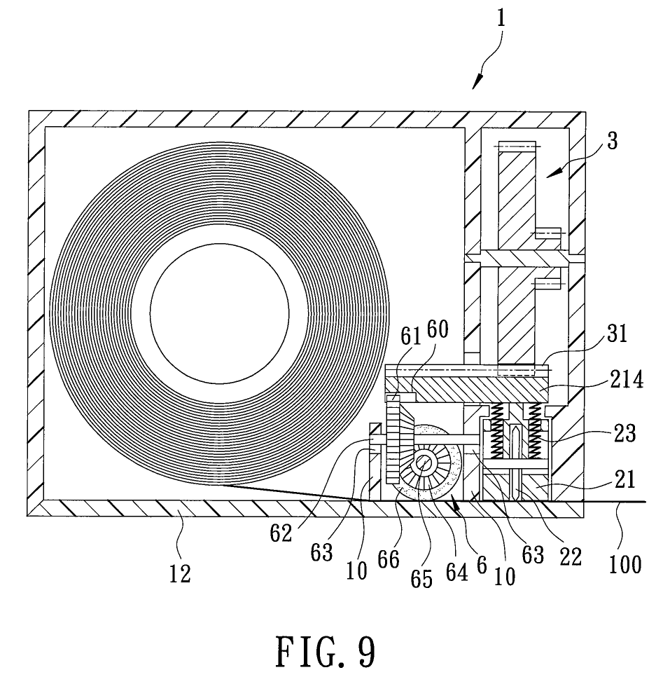

Referring to FIG. 9, the seventh preferred embodiment of the plastic film cutting device according to this invention is shown and differs from the first preferred embodiment in that the plastic film cutting device further includes a film driving unit 6 having a film-driving gear rack 60 provided on an opposite side of the top plate 214 of the cutter seat 21 opposite to the gear rack 31, a worm gear 61 meshing with and driven by the film-driving gear rack 60, a pinion 64 meshing with the worm gear 61, and a film-driving roller 66 connected to the pinion 64 and abutting against the lid 12 for driving movement of the plastic film 100 therebetween. In this embodiment, the worm gear 61 is mounted movably in the casing 1 for engaging and disengaging the pinion 64, and is mounted on an axle 62 which extends through two elongate slots 63 formed in two mounting plates 10 of the casing 1.

With the inclusion of the first and second cutting members 22 in the plastic film cutting device of this invention that are mounted movably in the casing 1, the aforesaid drawback associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A plastic film cutting device comprising:
a casing adapted to receive a roll of a plastic film therein and having an open end that defines an access opening for access into said casing, and a lid connected to said open end for covering and uncovering said access opening, said lid having first and second ends opposite to each other in a lengthwise direction; and
a cutting unit including a first cutting member disposed in said casing, movable between said first and second ends of said lid in the lengthwise direction, and abutting resiliently against said lid for cutting the plastic film therebetween.

2. The plastic film cutting device as claimed in claim 1, wherein said cutting unit further includes a cutter seat disposed slidably in said casing, movable in the lengthwise direction, and having two opposite ends opposite to each other in the lengthwise direction, said cutting unit further including a second cutting member abutting resiliently against said lid for cutting the plastic film therebetween, said first and second cutting members being mounted on said ends of said cutter seat, respectively.

3. The plastic film cutting device as claimed in claim 2, wherein said cutter seat is movable in the lengthwise direction between a first position, in which said first cutting member is disposed at said first end of said lid and said second cutting member is disposed at a middle position between said first and second ends of said lid, and a second position, in which said second cutting member is disposed at said second end of said lid and said first cutting member is disposed at the middle position between said first and second ends of said lid.

4. The plastic film cutting device as claimed in claim 1, wherein said cutting unit further includes an axle extending through said first cutting member, and a pair of first urging members disposed respectively at two opposite sides of said first cutting member and abutting against said axle for urging said first cutting member toward said lid.

5. The plastic film cutting device as claimed in claim 4, wherein each of said first urging members is in the form of a coil spring.

6. The plastic film cutting device as claimed in claim 4, wherein each of said first urging members is in the form of a torsion spring.

7. The plastic film cutting device as claimed in claim 1, wherein said cutting unit further includes a cutter seat disposed slidably in said casing and movable in the lengthwise direction between first and second positions, said first cutting member being mounted on said cutter seat, said plastic film cutting device further comprising a driving unit including a gear set connected to said cutter seat, a driving arm pivoted to said casing and connected to said gear set, and an operating knob connected and transverse to said driving arm and extending outwardly through said casing for driving rotation of said driving arm and said gear set and movement of said cutter seat between the first and second positions.

8. The plastic film cutting device as claimed in claim 7, wherein said gear set includes a first gear that is formed with a radially extending notch, said driving arm being provided with a driving pin transverse to said first gear and extending through said radially extending notch in said first gear for driving rotation of said first gear and movement of said cutter seat between the first and second positions.

9. The plastic film cutting device as claimed in claim 7, wherein said driving arm is rotatable from an upper position to a lower position for moving said cutter seat from the first position to the second position, said driving unit further including a second urging member for restoring said driving arm to the upper position.

10. The plastic film cutting device as claimed in claim 9, further comprising a third urging member mounted on said casing and disposed adjacent to said second end of said lid for restoring said cutter seat to the first position.

11. The plastic film cutting device as claimed in claim 8, wherein said gear set further includes a second gear connected to said first gear, and a gear rack provided on said cutter seat and meshed with said second gear.

12. The plastic film cutting device as claimed in claim 7, wherein said driving unit further includes a pair of pulleys mounted on said casing and disposed adjacent to said first and second ends of said lid, respectively, a belt wheel connected to said first gear and disposed between said pulleys, and a driving belt trained on said pulleys and said belt wheel and connected to said cutter seat for driving movement of said cutter seat between the first and second positions.

13. The plastic film cutting device as claimed in claim 1, wherein said cutting unit further includes a cutter seat disposed slidably in said casing and movable in the lengthwise direction between first and second positions, said first cutting member being mounted on said cutter seat, said plastic film cutting device further comprising a driving unit including a pair of pulleys mounted on said casing and disposed adjacent to said first and second ends of said lid, respectively, a belt wheel connected to said first gear and disposed between said pulleys, and a driving belt trained on said pulleys and said belt wheel and connected to said cutter seat for driving movement of said cutter seat between the first and second positions.

14. The plastic film cutting device as claimed in claim 13, wherein said driving unit further includes a motor, a driving wheel driven by said motor, a driven wheel connected to said belt wheel, and a second driving belt trained on said driving and driven wheels for driving rotation of said belt wheel and movement of said driving belt.

15. The plastic film cutting device as claimed in claim 8, wherein said driving arm is rotatable from an upper position to a lower position for moving said cutter seat from the first position to the second position, said driving unit further including a torsion spring abutting against said driving pin for restoring said driving arm to the upper position.

16. The plastic film cutting device as claimed in claim 11, wherein said cutter seat has a top plate that has two opposite ends and that is formed with two abutting protrusions protruding upwardly from said ends thereof, respectively, said gear rack being mounted movably on said top plate and being disposed between said ends of said top plate for abutting against one of said abutting protrusions when said gear rack is moved toward said second end of said lid, and for abutting against the other of said abutting protrusions when said gear rack is moved toward said first end of said lid.

17. The plastic film cutting device as claimed in claim 11, wherein said cutter seat has a top plate and a cutter-holding body that is detachably connected to and that engages said top plate in a wedging manner, said gear rack being mounted on said top plate, said first cutting member being mounted on said cutter-holding body.

18. The plastic film cutting device as claimed in claim 1, wherein said cutting unit further includes a cutter seat disposed slidably in said casing and movable in the lengthwise direction between first and second positions, said plastic film cutting device further comprising a film driving unit including a film-driving gear rack provided on said cutter seat, a worm gear meshing with and driven by said film-driving gear rack, a pinion meshing with said worm gear, and a film-driving roller connected to said pinion and abutting against said lid for driving movement of the plastic film therebetween.
